(19) United States
(12) Patent Application Publication
(10) Pub. No.: US 2023/0191972 A1
(43) Pub. Date: Jun. 22, 2023

(54) VEHICLE SUSPENDED SEATS

(71) Applicant: AGCO International GmbH, Neuhausen (CH)

(72) Inventor: Dirk Stallmeier, Marktoberdorf (DE)

(21) Appl. No.: 18/055,907

(22) Filed: Nov. 16, 2022

(30) Foreign Application Priority Data
Dec. 20, 2021 (GB) 2118536.8

(51) Int. Cl. B60N 2/90; B60N 2/00; B60N 2/52

(52) U.S. Cl. CPC B60N 2/919; B60N 2/002; B60N 2/52; B60N 2002/952

(57) ABSTRACT

A vehicle seat assembly including a vehicle seat mounted on a spring suspension system, the seat assembly having a safe mode into which it can be placed when the seat is unoccupied to avoid damage to the spring suspension system due to forces generated within the suspension system of an unoccupied seat. The seat assembly is configured to be placed in communication with a control system of an associated vehicle in which it is mounted and to invoke the safe mode in dependence on the vehicle being placed in a predetermined operating mode of the vehicle which is indicative that the seat will be unoccupied.

### FIELD

Aspects of the invention relate to vehicle seats which are mounted to an associated vehicle via a spring suspension system. Such seats are designed to isolate the driver from the vibrations present within the body of the vehicle and are not normally designed for use when the seat is not occupied.

### BACKGROUND

Increasingly, certain types of vehicle, for example agricultural tractors, are being called upon to operate in a driverless manner. For example, in the so-called leader-follower mode in which a tractor follows a leading machine copying or augmenting the operation of the lead machine. Other examples include autonomous driving and remotely controlled operation. Use of the vehicle with an unoccupied seat can lead to mechanical failures of the seat suspension system due to forces occurring within the seat assembly which it is not designed to withstand.

### BRIEF SUMMARY

According to an aspect of the present disclosure, there is provided a vehicle seat assembly including a vehicle seat mounted on a spring suspension system, the vehicle seat assembly having a safe mode into which it can be placed when the seat is unoccupied, the seat assembly being connectable with a control system of an associated vehicle to which the seat assembly is mounted and configured to invoke the safe mode when the associated vehicle is placed in a predetermined operating mode.

The safe mode is configured to avoid damage to the spring suspension system due to forces generated within the suspension system of an unoccupied seat. This is particularly advantageous when the vehicle is operated in a mode which does not require a diver/operator to be present, such as a leader-follower mode, and autonomous driving mode or a remote control mode.

The predetermined operating mode of the vehicle is a mode of operation which in which the vehicle seat is expected to be unoccupied.

The seat assembly may have a controller operatively connectable to a control system of an associated vehicle. The seat assembly controller may be operatively connected with the seat assembly to regulate actuation of the safe mode.

The seat assembly may configured such that it can be placed in the safe mode manually.

A sensor may be provided to detect the occupancy state of the vehicle seat. The vehicle seat assembly may be configured to automatically invoke the safe mode if the sensor detects the seat is not occupied, especially when the vehicle is switched on and is in use.

The safe mode may involve one or more of the following:
locking the seat in a specific position or configuration;
setting at least one specific operating characteristic, such as damping or spring rate of the spring suspension system;
locking or unlocking at least one specific seat assembly function, and
invoking a specific control mode for at least one specified function.

The safe mode may include locking the vehicle seat against movement. In an embodiment, the vehicle seat is locked at an intermediate position between a maximum seat height and minimum seat height.

In an embodiment, the seat assembly is configured so that when an associated vehicle is determined to be in the predetermined operating mode, a mechanical stop is actuated to prevent the seat moving into its maximum height position or to keep the seat in an intermediate position. The seat assembly may be configured so that the stop is deactivated when it is determined that the associated vehicle is no longer in the predetermined operating mode to enable normal operation of the suspension of the seat.

Operation of the stop may be coupled to the activation status of the vehicle. For example, the seat assembly may be configured such that when the vehicle is switched on and the associated vehicle is in the predetermined operating mode, the stop is automatically activated. The seat assembly may be configured such that when the vehicle is switched off the stop is deactivated and the seat may be moved into a predetermined position.

Where the safe mode involves locking or unlocking at least one specific seat assembly function, the at least one specific seat function may comprise one or more of a rotary adapter and a lateral suspension of the seat. Alternatively, or in addition, the safe mode may comprise deactivating or activating an active suspension system.

The safe mode may involve adjusting settings of the seat assembly such as a damping or spring rate of the spring suspension system. In an embodiment, the suspension system is controlled to assume a certain damping mode, in which the pressure of the air spring is maximized to minimize wear and tear damage during operation of the vehicle with the seat unoccupied when the seat assembly is in the safe mode.

Where the safe mode involves activating a specific control mode for at least one specified function, this may involve controlling the pressure of an air spring to activate a specific mode configured to minimize, or at least reduce, wear and tear damage. Another mode may be configured to minimize, or at least reduce, energy consumption by deactivating specific seat assembly functions such as an active suspension system. The active suspension system may, for example, be deactivated when the vehicle is used in conditions which place little demand on the active suspension such as when being driven on well maintained, e.g. relatively smooth, surfaces such as on a road. A further mode of control may involve a maximization of the suspension capability for heavy duty operations, say for use in off-road conditions.

According to an aspect of the disclosure, there is provided a vehicle having a vehicle seat assembly comprising a vehicle seat mounted on a suspension system, the seat assembly having a safe mode into which the seat assembly can be placed when the seat is unoccupied to avoid damage to at least one of the seat and the suspension system due to forces generated within the suspension system of an unoccupied vehicle seat, wherein the seat assembly is operatively connected with a control system of the vehicle and the arrangement configured such that the seat assembly is automatically placed in the safe mode when the vehicle enters a predetermined operating mode not requiring the vehicle seat to be occupied.

The vehicle may be a utility vehicle or mobile machine. The vehicle may be an agricultural vehicle or mobile machine, such as a tractor or combine harvester, sprayer or the like. The vehicle may be a construction vehicle or mobile machine, such as an excavator, digger, or the like.

### BRIEF DESCRIPTION OF THE DRAWINGS

One or more embodiments of the disclosure will now be described, by way of example only, with reference to the accompanying drawings, in which:

FIG. 1 shows diagrammatically two tractors following a lead tractor in a so-called leader-follower mode of operation;

FIG. 2 shows a side view of a typical tractor seat assembly including a seat mounted on an air suspension spring and a seat locking actuator shown diagrammatically adjacent to the seat assembly;

FIG. 3 shows diagrammatically the seat and actuator of FIG. 2 with the seat in its maximum height, minimum height and interim height positions, and

FIG. 4 shows a control algorithm for determining when the safe mode of the present invention should be invoked.

### DETAILED DESCRIPTION

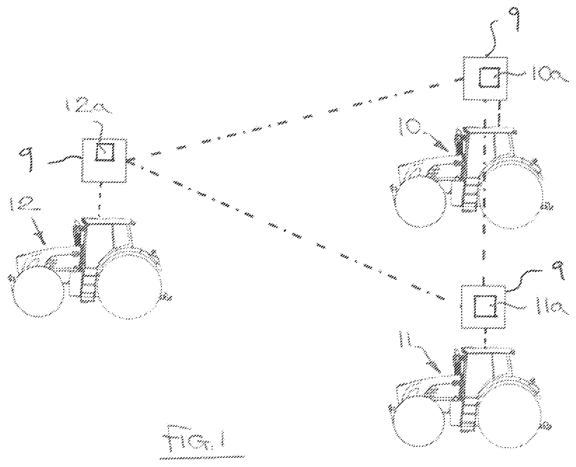

Referring to the drawings, a typical tractor formation when operating in the so called leader-follower mode is shown in FIG. 1 in which two tractors 10 and 11 follow lead tractor 12. The three tractors are interconnected wirelessly via respective control units 10a, 11a and 12a so that follower tractors 10 and 11 can carry out the same tasks as the lead tractor 12 or can be programmed to carry out complementary tasks without the need for tractors 10 and 11 to carry their own driver. The control units 10a, 11a, 12a may form part of a control system of the respective tractor, indicated schematically at 9. The control system 9 (also referred to as an infrastructure control system) will typically include one or more controllers (ECU) and devices interconnected and communicating via a controller area network (CAN bus) or via a communications medium using other standard or proprietary communication protocols (e.g., RS 232, etc.). Communication may be achieved over a wired medium, wireless medium, or a combination of wired and wireless media.

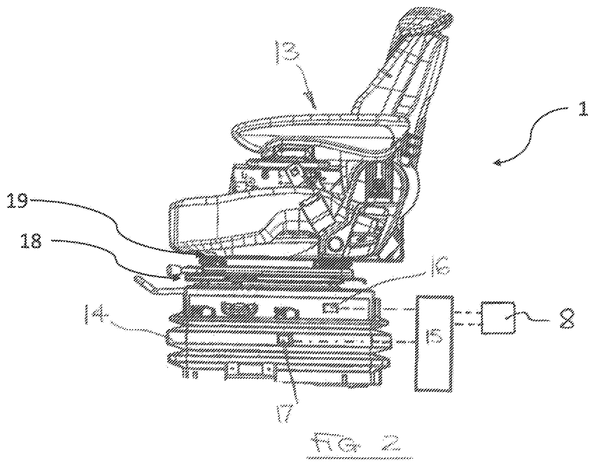

Each tractor has a driver's seat assembly 1, a typical example of which is shown in FIG. 2. The seat assembly 1 includes a seat 13 mounted on a suspension spring 14 which forms part of a suspension system for isolating the driver from vibrations present within the tractor body during use. Typically, the spring 14 is an air filled bellows which enables the height of the seat to be easily adjusted for different operators in addition to isolating the driver from vibrations but other types of spring may be used. A rotary adaptor 18 is located between the spring 14 and the seat 13 that enables the seat 13 to be swivelled about a vertical axis. In addition, the seat assembly 1 also comprises a lateral suspension system 19 (sometimes referred to as a lateral or side to side isolation system). The lateral suspension system 19 enables the seat to move laterally by a limited amount against a spring or damping force and helps to isolate the driver from vibrations in a lateral direction with respect to the normal driving direction. The lateral suspension system may include at least one air filled suspension spring (e.g. a gas filled strut) which is arranged between the seat cushion and the rotary adaptor 18.

It should be appreciated that a seat assembly 1 according to the present disclosure can take other forms and may not comprise all of the above features. For example, the seat assembly 1 may not be provided with a lateral suspension system 19 and/or a rotary adaptor 18.

In accordance with an aspect of the present disclosure, the driver's seat assembly 1 has a safe mode of operation into which the seat assembly can be placed when the seat is unoccupied, especially whilst the vehicle is in use, to avoid damage to the seat and/or the spring suspension system due to forces generated within the suspension system of an unoccupied vehicle seat assembly.

In an embodiment, the seat assembly 1 is communicatively connected with the control system 9 of the associated vehicle 10, 11, 12 and is arranged to invoke the safe mode when the associated vehicle is placed in a predetermined operating mode. The predetermined operating mode being one in which usually does not require a driver/operator to be present in the vehicle and where the vehicle seat is, therefore expected to be unoccupied. In a non-limiting example, the predetermined operating mode which invokes the safe mode may include any one or more of the following: leader-follower mode, autonomous driving mode and remote control mode.

When the safe mode is invoked this may involve one or more of the following actions:
locking the seat or seat assembly in a specific position;
setting specific operating characteristics such as damping or spring rate of the seat suspension 14;
locking or unlocking specific seat functions, and
invoking a specific control mode for specified seat assembly functions.

The vehicle seat assembly 1 may have a controller indicted schematically at 8 which is operatively connected with (in communication with) the control system 9 of the vehicle (10, 11, 12) and which is operative to place the seat assembly into and out of its safe mode. The seat assembly controller 8 may be part of the seat assembly itself or may be provided elsewhere in the vehicle and operatively connected with the seat assembly 1 in order to control one or more seat assembly functions.

The controller 8 may be in the form of an ECU which provides the control logic for the seat assembly 1. In one embodiment, the controller 8 comprises one or more processors, input/output (I/O) interface(s), and memory, all coupled to one or more data busses. The memory may include any one or a combination of volatile memory elements (e.g., random-access memory RAM, such as DRAM, and SRAM, etc.) and non-volatile memory elements (e.g., ROM, hard drive, tape, CDROM, etc.). The memory may store a native operating system, one or more native applications, emulation systems, or emulated applications for any of a variety of operating systems and/or emulated hardware platforms, emulated operating systems, etc. In one embodiment the memory comprises an operating system and seat assembly operating software. It should be appreciated by one having ordinary skill in the art that in some embodiments, additional or fewer software modules (e.g., combined functionality) may be employed in the memory or additional memory. In some embodiments, a separate storage device may be coupled to the data bus, such as a persistent memory (e.g., optical, magnetic, and/or semiconductor memory and associated drives).

The processor may be embodied as a custom-made or commercially available processor, a central processing unit (CPU) or an auxiliary processor among several processors, a semiconductor based microprocessor (in the form of a microchip), a macro processor, one or more application specific integrated circuits (ASICs), a plurality of suitably configured digital logic gates, and/or other well-known electrical configurations comprising discrete elements both individually and in various combinations to coordinate the overall operation of the controller 26.

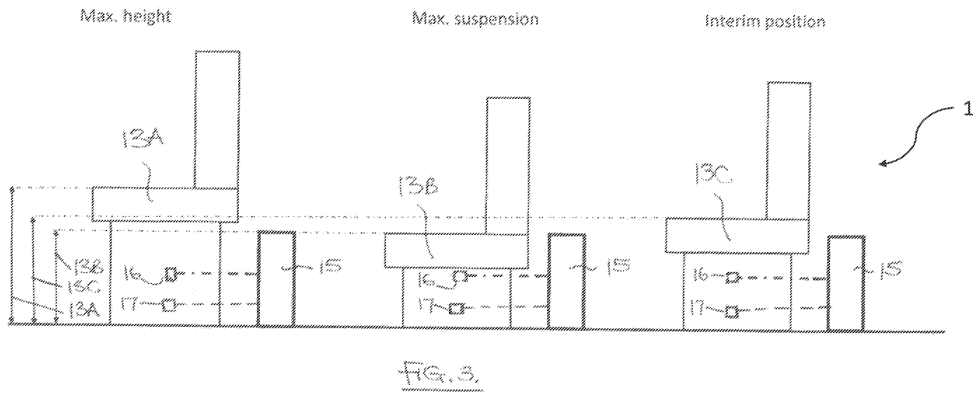

In an embodiment where the safe mode involves locking the seat 13 in a specific position, an actuator, shown diagrammatically at 15 in FIG. 2, is operative to control engagement of a stop 17 to lock the seat 13 in a predetermined position to place the seat assembly in the safe mode. Typically the seat 13 is locked in an intermediate position 13C (see FIG. 3) which lies between its maximum and minimum height positions 13A and 13B respectively. Operation of the actuator 17 may be regulated by the vehicle seat controller 8 in dependence on the operating mode of the vehicle 10, 11, 12. For example, the seat assembly controller 8 may provide one or more control signals to cause the actuator 15 to engage the stop 17 to place the seat assembly in the safe more when the vehicle enters a mode of operation in which the vehicle seat 13 is expected to be unoccupied, such as a leader-follower mode (i.e. where the vehicle 10, 11 is automatically following a lead vehicle), autonomous driving mode or remote control mode. The seat assembly control 8 may be configured to take the seat assembly 1 out of the safe mode if the vehicle operating mode changes to one in which the seat is expected to be occupied, that is to say is the vehicle operating mode is not one of the predetermined operating modes that trigger the safe mode. A sensor 16 may be provided (see FIG. 2) which detects the occupancy state of the seat 13. The sensor 16 may be used to confirm that the vehicle seat is not occupied when the vehicle enters a mode which triggers the seat assembly 1 entering the safe mode. However, the system can be configured so that the seat assembly 1 is placed in the safe mode depending on the occupancy status of the seat 13 as detected by the sensor 16 even when the vehicle is not in a predetermined mode of operation. In an embodiment, operation of the stop 17 is coupled to the activation status of the vehicle. For example, if the vehicle is switched on and no driver is sitting on the seat 13 the stop 17 may be automatically activated. If the vehicle is switched off then the stop 17 may be deactivated and the seat may be moved into a predetermined (e.g. most relaxed) position.

In the above embodiment, the seat assembly 1 is arranged so that when a driver of the tractor leaves the seat 13, or the system determines the seat is unoccupied due to the operating mode of the vehicle, the seat 13 is prevented from moving into its maximum height position 13A but is kept in the intermediate position 13B by the mechanical stop 17. In an embodiment, the stop 17 is deactivated when the driver returns to his seat 13 as detected by the sensor 16, or the mode of operation of the vehicle changes to one in which a driver is expected to be present, so that the normal operation of the suspension of the seat returns. The stop 17 may also be engaged/disengaged manually, say by the driver.

Alternatively, or additionally, the safe mode may include locking the rotary adapter 18 to prevent the seat 13 from rotating and colliding with other components or the boundaries of the cabin when the seat 13 is unoccupied. Similarly, the lateral suspension 19 could be locked in the safe mode and unlocked for normal use when the vehicle is not operating in a predetermined mode and/or the seat 13 is occupied.

In a further alternative, the safe mode may involve adjusting settings of the seat assembly such as the damping or spring rate of the spring suspension system 14. This can include controlling the seat 13 and the suspension system 14 to assume a certain damping mode in which the pressure of the air spring 14 is maximized to minimize wear and tear damage during operation of the vehicle with the seat unoccupied.

Once the seat 13 is reoccupied or the vehicle operating mode changed to one in which the seat is expected to be occupied, the configuration of some or all of the above functions may be reversed. For example, functions that are locked in the safe mode may be unlocked and adjusted settings, such as damping or spring rate, can be returned to normal. Thus the safe mode can be automatically invoked and revoked as and when the seat 13 is vacated and re-occupied and/or dependent on the mode of operation of the vehicle. This might be especially advantageous if the operator is switching multiple times between the different vehicles during a work day or where the operating mode of the vehicle is being changed regularly. In this embodiment, the safe mode may activated or deactivated in dependency on the output from the seat occupancy sensor 16 and/or in dependency on the mode of operation of the vehicle.

In an embodiment, the seat assembly 1 can also be placed in its safe mode manually when required.

The vehicle control system 9 may send a request to the seat assembly 1, e.g. to the seat assembly controller 8, to place the seat assembly 1 in the safe mode whenever the vehicle 10, 11 enters an operating mode which does not require a driver/operator to be present. Alternatively, the seat assembly 1 may not have a dedicated controller and the vehicle control system 9 be configured to automatically place the seat assembly in the safe mode when the vehicle is placed in a predetermined operating mode. The vehicle control system 9 may for example be configured to control actuation of the mechanical stop 17 via the actuator 15 in the embodiment described above. Where a vehicle 10, 11 is being used as a follower vehicle in a leader-follower operation, the adjustment to the safe mode can be controlled and started by the leader vehicle 12, which is in communication with the follower vehicle 10, 11. The leader vehicle 12 can, for example, send a control signal to the follower vehicle or vehicles 10, 11 to prepare a leader-follower operation, which includes the adjustment of certain vehicle parameters of the following vehicle (s) and which includes placing the seat assembly 1 in the safe mode. In other embodiments, the seat assembly 1 may atomically recognise when the vehicle enters an operating mode which does not require a driver/operator to be present and apply the safe mode. In this arrangement, the seat assembly will typically have its own controller 8.

In addition to a safe mode, specific control modes for specified functions may be adopted for the seat assembly 1. This can include controlling the seat 13 and the suspension system 14 to assume a certain damping mode in which the pressure of the air spring 14 is maximized to minimize wear and tear damage during operation of the vehicle in extreme operating situations. An alternative mode is energy saving mode, whereby the energy consumption of the seat assembly 1 is minimized by deactivating systems not required by the current operating conditions. For example, an active suspension system may be deactivated when the operating conditions are not placing much demand on the active suspension. This mode may be advantageous during light operating conditions like snow clearing or simple transport tasks on asphalt streets. In contrast, another mode of control may be configured to maximize operation of the suspension system, say when the vehicle is used in heavy terrain. Such a mode may include an activation of the active suspension system and an unlocking of the lateral suspension 19 of the seat. This aspect may be adopted with or without a safe mode.

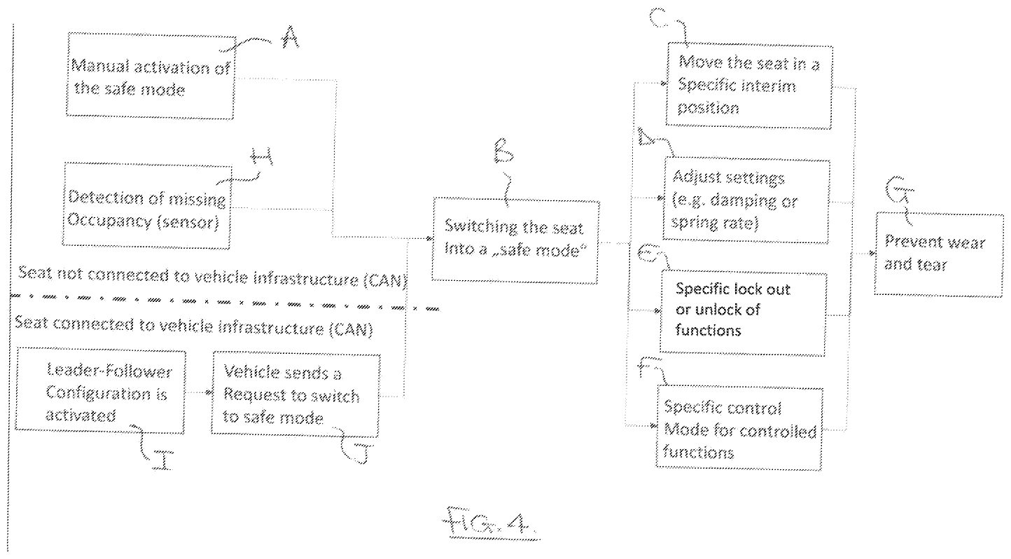

FIG. 4 shows several examples of an algorithm suitable for use in controlling the operation of a suspended seat in accordance with the principles of the present invention.

In a simple arrangement, safe mode of the seat assembly is activated manually as indicated at box A and the seat assembly 1 is switched into safe mode as indicated by box B, typically invoking one or more of the actions set out in boxes C to F. This results in reduced wear and tear on the seat as indicated by box G. Alternatively, switching of the seat into a safe mode may be initiated in response to a sensor detecting that the seat is not occupied as indicated in box H or by the vehicle entering a predetermined vehicle operating mode in which it is likely the seat will be unoccupied as indicated by box I. This may case the vehicle control system to send a request to the seat assembly 1 to adopt the safe mode as indicated by box J. In a further embodiment, a user may place the seat assembly in a safe mode via an input in a HMI of the vehicle control system. In some embodiments, it may be possible to place the seat assembly 1 in a safe mode using any one of two or more of the above methods. For example, a seat assembly according to the invention can be configured so that the safe mode can be actuated by any one or more of a manual activation A, in dependence on a signal from a seat occupant sensor H, and/or in response to the vehicle being placed in a predetermined operating mode I.

The present invention thus provides a simple and effective solution which prevents damage to a suspended vehicle seat 13 when the vehicle is operated without any driver on the seat.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventors. Further, embodiments of the disclosure have utility with different and various machine types and configurations.

What is claimed is:

1. A vehicle seat assembly comprising a vehicle seat mounted on a suspension system, the seat assembly having a safe mode into which the seat assembly can be placed when the seat is unoccupied to avoid damage to at least one of the seat and the suspension system due to forces generated within the suspension system of an unoccupied vehicle seat, wherein the seat assembly is configured to be placed in communication with a control system of an associated vehicle to which the seat assembly is mounted and to invoke the safe mode in dependence on the associated vehicle being placed in a predetermined operating mode.

2. A vehicle seat assembly according to claim 1, wherein the seat assembly is also configured to be placed in its safe mode manually.

3. A vehicle seat assembly according to claim 1, wherein the seat assembly is provided with a sensor configured to detect an occupancy state of the vehicle seat, the seat assembly being configured to automatically invoke the safe mode when the sensor detects that the vehicle seat is unoccupied, at least when the vehicle is switched on.

4. A vehicle seat assembly according to claim 1, wherein the seat assembly includes a sensor for detecting an occupancy state of vehicle seat, the vehicle seat assembly being configured such that if the associated vehicle is switched on and the sensor detects that the vehicle seat is unoccupied, a seat stop is automatically activated to limit movement of the vehicle seat.

5. A vehicle seat assembly according to claim 4, wherein the vehicle seat assembly is configured such that if the vehicle is subsequently switched off, the stop is deactivated and/or the seat is moved into a predetermined position.

6. A vehicle seat assembly as claimed in claim 4, wherein the vehicle seat assembly is configured such that if the sensor detects that the vehicle seat is subsequently occupied, the stop is deactivated.

7. A vehicle seat assembly according to claim 1, in which placing the seat in safe mode involves at least one of the following actions: locking the seat in a specific position; setting at least one specific operating characteristics such as damping or spring rate; locking or unlocking at least one seat function, and invoking a specific control mode for specified seat assembly functions.

8. A vehicle seat assembly according to claim 1, in which the seat is locked against movement in an intermediate position between a maximum seat height and minimum seat height when in its safe mode.

9. A vehicle seat assembly according to claim 8, wherein the seat suspension enables the vehicle seat to move through a range of vertical movement between a maximum height position and a minimum height position when the seat assembly is not in the safe mode, the seat assembly configured in use such that if it is determined that the associated vehicle is operating in the predetermined operating mode, a mechanical stop is actuated to prevent the seat moving to its maximum height position and/or to hold the seat in an intermediate position between its maximum and minimum height positions.

10. A vehicle seat assembly as claimed in claim 9, wherein, the seat assembly is configured such that if, following actuation of the mechanical stop, it is determined that the associated vehicle is no longer operating in the predetermined operating mode, the mechanical stop is deactivated to enable the seat to move over its full range of vertical movement as permitted by the suspension system.

11. A vehicle seat assembly according to claim 1, in which the predetermined operating mode of the associated vehicle comprises at least one mode selected from a leader-follower mode, an autonomous driving mode, and a remote control mode.

12. A vehicle seat assembly according to claim 7, wherein when the safe mode involves locking or unlocking at least one seat function, the at least one seat function which is locked or unlocked comprises at least one of a rotary adapter, a the lateral suspension, and an active suspension.

13. A seat according to claim 7, wherein when the safe mode involves invoking a specific control mode for specified seat assembly functions, the specific control mode comprises at least one of an energy consumption minimization mode, a wear and tear minimization mode, and a suspension maximization mode.

14. A vehicle comprising a vehicle seat assembly according to claim 1 and a control system, the seat assembly being in communication with the control system, the system configured such that the seat assembly is placed in the safe mode when the vehicle is operated in a predetermined operating mode.

15. A vehicle having a vehicle seat assembly comprising a vehicle seat mounted on a suspension system, the seat assembly having a safe mode into which the seat assembly can be placed when the seat is unoccupied to avoid damage to at least one of the seat and the suspension system due to forces generated within the suspension system of an unoccupied vehicle seat, wherein the seat assembly is operatively connected with a control system of the vehicle and the arrangement configured such that the seat assembly is automatically placed in the safe mode when the vehicle enters a predetermined operating mode not requiring the vehicle seat to be occupied.
